(19) United States
(12) Patent Application Publication
(10) Pub. No.: US 2013/0284529 A1
(43) Pub. Date: Oct. 31, 2013

(54) COOLING SYSTEM FOR MOBILE MACHINE

(71) Applicants: John Franklin Kral, Plainfield, IL (US); Hector Marcel Matthys, Cottonwood, MN (US)

(72) Inventors: John Franklin Kral, Plainfield, IL (US); Hector Marcel Matthys, Cottonwood, MN (US)

(21) Appl. No.: 13/459,673

(22) Filed: Apr. 30, 2012

(51) Int. Cl. F28F 27/00; G05D 23/00; B60K 11/06

(52) U.S. Cl. 180/68.1; 165/11.1; 165/287

(57) ABSTRACT

A cooling system for a mobile machine having a heat-sensitive component is provided. The cooling system may include a first coolant tank and a pump configured to circulate coolant from the first coolant tank through the heat-sensitive component. The cooling system may also include a heat exchanger configured to receive coolant from the heat-sensitive component and transfer heat to ambient air passing through the heat exchanger, and a blower configured to direct ambient air through the heat exchanger. The cooling system may further include a first temperature sensor configured to generate a first signal indicative of a temperature of ambient air, and a controller in communication with the blower and the first temperature sensor. The controller may be configured to selectively deactivate the blower based on the first signal.

### TECHNICAL FIELD

The present disclosure relates generally to a cooling system, and more particularly, to a cooling system for a mobile machine.

### BACKGROUND

Mobile machines operate in environments that can change dramatically within a relatively short period of time. For example, during a single trip between destinations, a locomotive can operate in an open environment and, at select times during the trip, in a closed environment such as in a tunnel. When the locomotive operates in the open environment, the locomotive is provided with an adequate amount of relatively cool air that is used for both combustion and for cooling engines and electronics of the locomotive. When the locomotive operates in the closed environment, the amount of available air can be less and/or the temperature of the air can be higher. For this reason, in the closed environments, performance of the locomotive can diminish naturally through overheating of the engine and/or electronics, or the locomotive may be purposely derated so as to protect components of the locomotive from overheating.

One attempt to improve cooling of a locomotive in a closed environment is described in U.S. Pat. No. 5,561,602 (“the '602 patent”) of Bessler that issued on Oct. 1, 1996. The '602 patent describes a locomotive having a liquid-cooled engine and an air-cooled controller. The '602 patent also describes a tunnel indicator that can be initiated either manually by an operator, or automatically by a GPS system. When the tunnel indicator initiates a tunnel operation, for example one or two miles before a tunnel, the controller activates a blower to operate at full speed and maximize cooling of the controller prior to entering the tunnel. Likewise, the controller causes a motor of the heat exchanger to operate at full speed in order to increase cooling of the engine before entering the tunnel. This pre-cooling effectively increases the tolerance of the locomotive to thermal overload, maximizing the time that the locomotive can spend in the tunnel without adverse consequences.

Although the system of the '602 patent may be capable of increasing the operating limits of a locomotive within a tunnel, it may still be less than optimal. Specifically, because the system of the '602 patent only pre-cools the engine and associated controller, it may not prevent derating of the engine and electronics in longer tunnels. Additionally, the system of the '602 patent requires either manual activation, which can be prone to operator error, or GPS activation, which can be more complicated and expensive.

The cooling system of the present disclosure solve one or more of the problems set forth above and/or other problems with existing technologies.

### SUMMARY

In one aspect, the disclosure is directed to a cooling system for a mobile machine having a heat-sensitive component. The cooling system may include a first coolant tank and a pump configured to circulate coolant from the first coolant tank through the heat-sensitive component. The cooling system may also include a heat exchanger configured to receive coolant from the heat-sensitive component and transfer heat to ambient air passing through the heat exchanger, and a blower configured to direct ambient air through the heat exchanger. The cooling system may further include a first temperature sensor configured to generate a first signal indicative of a temperature of ambient air, and a controller in communication with the blower and the first temperature sensor. The controller may be configured to selectively deactivate the blower based on the first signal.

In another aspect, the disclosure is directed to a method of cooling a mobile machine. The method may include circulating coolant from a main coolant tank through a heat-sensitive component of the mobile machine, and directing coolant from the heat-sensitive component through a heat exchanger. The method may also include activating a blower to generate a flow of ambient air through the heat exchanger, and determining a temperature of the ambient air. The method may further include selectively deactivating the blower based on the temperature of the ambient air.

### BRIEF DESCRIPTION OF THE DRAWINGS

FIG. 1 is a pictorial illustration of an exemplary disclosed mobile machine;

FIG. 2 is a diagrammatic illustration of an exemplary disclosed cooling system that may be used in conjunction with the mobile machine of FIG. 1; and

FIG. 3 is a flowchart depicting an exemplary disclosed method of controlling the cooling system of FIG. 2.

### DETAILED DESCRIPTION

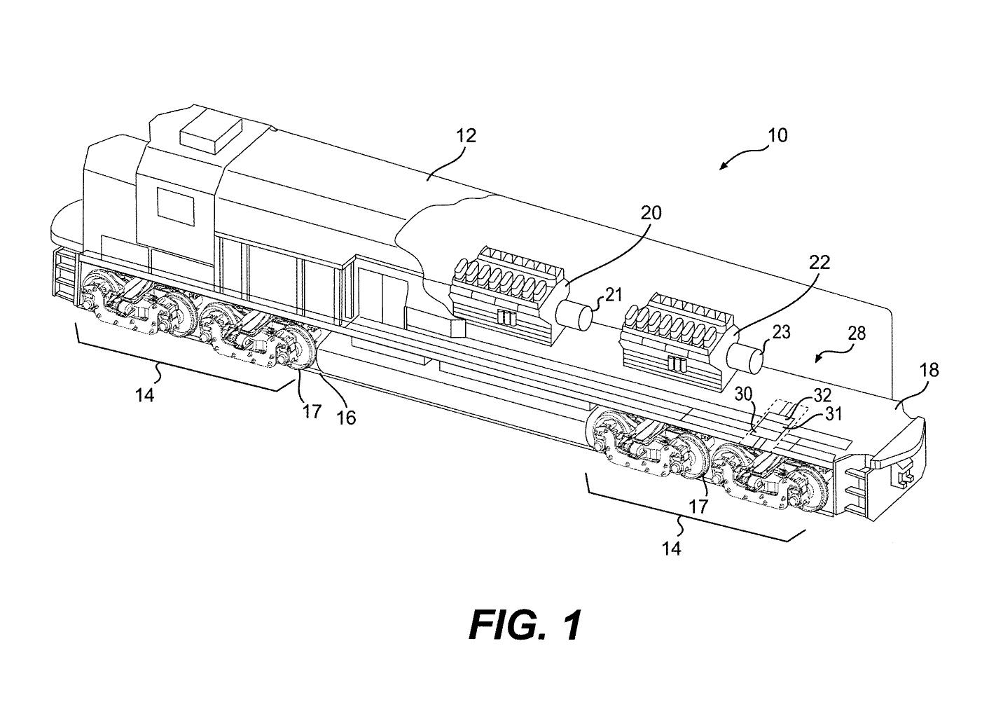

FIG. 1 illustrates an exemplary embodiment of a mobile machine 10, such as a locomotive, that includes a car body 12 supported at opposing ends by a plurality of trucks 14 (e.g., two trucks 14). Each truck 14 may be configured to engage a track 16 via a plurality of wheels 17, and support a frame 18 of car body 12. Any number of engines may be mounted to frame 18 and configured to produce electricity that drives wheels 17 included within each truck 14. In the exemplary embodiment shown in FIG. 1, mobile machine 10 includes a first engine 20 configured to drive a first generator 21, and a second engine 22 configured to drive a second generator 23. Engines 20, 22 may be aligned lengthwise on frame 18 in a travel direction of locomotive 10. One skilled in the art will recognize, however, that first engine 20 and second engine 22 may be arranged in tandem, transversally, or in any other orientation on frame 18. Mobile machine 10 may also include power electronics 28 operatively supported by frame 18 associated with one or more traction motors 30, and used to drive wheels 17.

Power electronics 28 may include heat-sensitive components including, among other things, a chopper assembly 31 and an auxiliary power module 32. Chopper assembly 31 may be configured to control power flow to a plurality of traction motors 30 located between opposing wheels 17 of mobile machine 10. Each individual chopper may be associated with and control power directed to an individual traction motor 30, though any other suitable configuration may alternatively be utilized. Auxiliary power module 32 may be configured to condition electrical power generated by engines 20, 22. That is, auxiliary power module 32 may include components configured to convert alternating current (AC) from generators 21, 23 into direct current (DC) that can be used by other electrical systems (not shown) of mobile machine 10. Additionally or alternatively, auxiliary power module 32 may include components configured to convert direct current (DC) into alternating current (AC) of various frequencies and voltages to power additional electrical systems (not shown) of mobile machine 10.

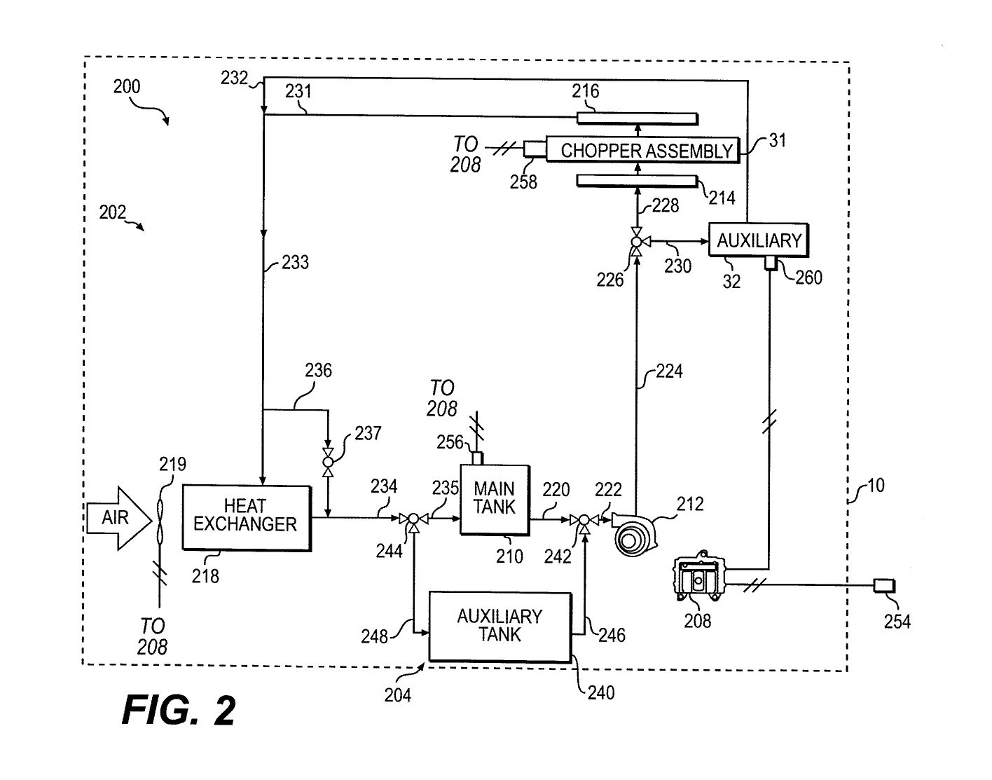

As shown in FIG. 2, mobile machine 10 may be equipped with a cooling system 200 that is configured to cool power electronics 28 of mobile machine 10. Cooling system 200 may include, among other things, a primary circuit 202 and an auxiliary circuit 204. Coolant flows may be regulated through one or both of primary and auxiliary circuits 202 and 204 by a controller 208 to maintain temperatures of power electronics 28 within desired limits.

Primary circuit 202 may include components that cooperate to selectively cool power electronics 28. In particular, primary circuit 202 may include a main coolant tank 210 supported by frame 18, a primary pump 212, a chopper inlet manifold 214, a chopper outlet manifold 216, a heat exchanger 218, and an associated blower 219. Coolant may flow from main coolant tank 210 via passages 220, 222, and 224 to a control valve 226. From control valve 226, coolant may flow to chopper inlet manifold 214 via passage 228 and/or to auxiliary power module 32 via passage 230. Coolant may flow from chopper inlet manifold 214 through chopper assembly 31, and from chopper assembly 31 through chopper outlet manifold 216. Coolant may flow from chopper outlet manifold 216 to heat exchanger 218 via passage 231. Coolant may flow from auxiliary power module 32 to heat exchanger 218 via passage 232. Passages 231 and 232 may be connected to heat exchanger 218 via a common passage 233. Coolant may exit heat exchanger 218 and be directed back to main coolant tank 210 via passages 234 and 235. Primary pump 212 may be connected between passages 222 and 224 to generate the flow of coolant within primary circuit 202. A heat exchanger bypass passage 236, having a heat exchanger bypass valve 237 (e.g., a mechanical thermostat valve), may selectively direct some or all of the coolant from common passage 233 around heat exchanger 218 directly to passage 234 in response to one or more inputs, for example in response to a temperature of coolant in common passage 233 falling below a bypass threshold setting of heat exchanger bypass valve 237.

Primary pump 212 may be engine-driven to generate the flow of coolant described above. Coolant such as water, glycol, a water/glycol mixture, a blended air mixture, or any other heat transferring fluid may be pressurized by primary pump 212. In particular, primary pump 212 may include an impeller (not shown) disposed within a volute housing having an inlet and an outlet. As the coolant enters the volute housing, blades of the impeller may be rotated by operation of one or both of engines 20, 22 to push against the coolant, thereby pressurizing the coolant. An input torque imparted by one or both of engines 20, 22 to primary pump 212 may be related to a pressure of the coolant, while a speed imparted to primary pump 212 may be related to a flow rate of the coolant. It is contemplated that primary pump 212 may alternatively embody a piston type pump, if desired, and may have a variable or constant displacement. It is also contemplated that primary pump 212 may alternatively be electrically driven, if desired.

Heat exchanger 218 may embody the main radiator of power electronics 28 and be situated to dissipate heat from the coolant before it passes through power electronics 28. It is contemplated that heat exchanger 218 may also function as the radiator used to cool engines 20, 22, if desired. Heat exchanger 218 may be a liquid-to-air type of heat exchanger. That is, a flow of air may be directed through channels of heat exchanger 218 such that heat from coolant within adjacent channels is transferred to the air. In this manner, the coolant passing through power electronics 28 may be cooled to below a maximum temperature threshold of power electronics 28.

Blower 219 may be associated with heat exchanger 218 and configured to generate the flow of cooling air. In particular, blower 219 may include an input device (not shown) such as a belt-driven pulley, a hydraulically-driven motor, or an electrically-powered motor that is mounted to or otherwise associated with engines 20, 22, and fan blades (not shown) fixedly or adjustably connected to the input device. The input device may be powered by engines 20, 22 to cause the connected fan blades to blow or draw air across heat exchanger 218.

Control valve 226 may be a proportional type valve having a valve element movable to regulate a flow of coolant. The valve element may be solenoid-operable to move between a flow-passing position and a flow-blocking position. In the flow-passing position, control valve 226 may permit substantially all of the coolant to flow through passage 228 and chopper assembly 31. In the flow-blocking position, control valve 226 may completely block coolant from flowing to chopper assembly 31 by diverting substantially all the coolant to flow through passage 230 and auxiliary power module 32. Control valve 226 may also include an intermediate position between the flow-passing position and the flow-blocking position. In the intermediate position, control valve 226 may permit some of the coolant to flow through passage 228 and chopper assembly 31, while diverting a remaining portion of the coolant through passage 230 and auxiliary power module 32. While control valve 226 is described as being a proportional-type valve, a plurality of throttle-type valves (not shown) associated with each of chopper assembly 31 and auxiliary power module 32 may alternatively be utilized.

Auxiliary circuit 204 may include an auxiliary coolant tank 240, an outlet control valve 242, and an inlet control valve 244. Auxiliary coolant tank 240 may be supported by frame 18 and be substantially isolated from main coolant tank 210 when the temperature of ambient air is lower than the temperature of the coolant in primary circuit 202. Primary pump 212 may circulate coolant from auxiliary coolant tank 240 into primary circuit 202 via passages 222 and 246 when outlet and inlet control valves 242, 244 are open. Outlet and inlet control valves 242, 244 may both be proportional type valves having valve elements movable to regulate a flow of coolant. The valve elements of outlet and inlet control valves 242, 244 may be solenoid-operable to move between flow-passing and flow-blocking positions. In the flow-passing positions, substantially all of the coolant passing through primary pump 212 may come from auxiliary circuit 204. In the flow-blocking positions, coolant may be inhibited from flowing through auxiliary circuit 204. Outlet and inlet control valves 242, 244 may also include intermediate positions in between the flow-passing and flow-blocking positions in which some of the coolant from main coolant tank 210 and some of the coolant from auxiliary coolant tank 240 may be pushed through power electronics 28 by primary pump 212. Coolant may return to auxiliary coolant tank 240 from heat exchanger 218 via passages 234 and 248.

Controller 208 may be a single microprocessor or multiple microprocessors that include a mechanism for controlling an operation of cooling system 200. Numerous commercially available microprocessors can be configured to perform the functions of controller 208. It should be appreciated that controller 208 could readily be embodied in a general engine or machine microprocessor capable of controlling numerous engine and/or machine functions. Controller 208 may include a memory, a secondary storage device, a processor, and any other components for running an application. Various other circuits may be associated with controller 208 such as power supply circuitry, signal conditioning circuitry, solenoid driver circuitry, and other types of circuitry.

Controller 208 may rely on input from one or more sensors during regulation of cooling system 200. In the disclosed exemplary embodiment, controller 208 may rely on at least one sensor 254 configured to measure an ambient air temperature outside of mobile machine 10, at least one sensor 256 configured to measure a temperature of coolant flowing through primary circuit 202, at least one sensor 258 associated with chopper assembly 31, and at least one sensor 260 associated with auxiliary power module 32, although any number and types of sensors may be utilized. Sensors 254, 256, 258, and 260 may embody, for example, temperature sensors configured to generate signals indicative of an ambient temperature outside of mobile machine 10, a temperature of coolant within primary circuit 202, a temperature of chopper assembly 31, and a temperature of auxiliary power module 32, respectively. Sensors 254, 256, 258, and 260 may direct corresponding signals to controller 208 for further processing.

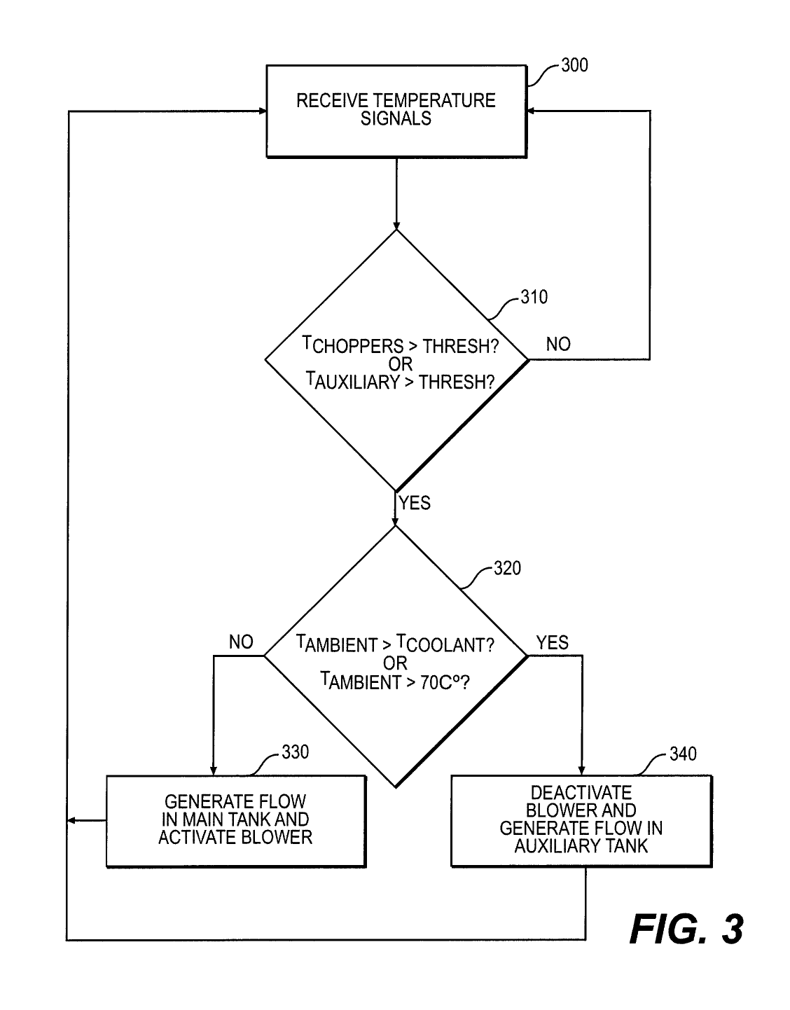

FIG. 3 illustrates an exemplary cooling system process performed by controller 208. FIG. 3 will be discussed in more detail in the following section to better illustrate the disclosed concepts.

### INDUSTRIAL APPLICABILITY

The disclosed cooling system may be applicable to any mobile machine required to operate in varying temperature conditions, such as in tunnels. The disclosed cooling system may enhance machine cooling by controlling blower operation and/or use of an auxiliary circuit when the temperature of ambient air outside of a mobile machine is higher than the temperature of coolant flowing within the machine. Operation of cooling system 200 will now be described.

Controller 208 may receive an output from sensors 258 and 260 to determine the respective temperatures of chopper assembly 31 and auxiliary power module 32 (step 300). Controller 208 may then determine if a temperature of chopper assembly 31 and/or auxiliary power module 32 is higher than a cooling threshold temperature (e.g., about 30° C., step 310). The cooling threshold temperature may be set lower than maximum temperature thresholds (e.g., about 70° C.) of chopper assembly 31 and/or auxiliary power module 32 in order to prevent damage to those components. When controller 208 determines that the temperature of chopper assembly 31 and/or auxiliary power module 32 is lower than the cooling threshold temperature, controller 208 may return to step 300. If, however, controller 208 determines that the temperature of chopper assembly 31 and/or auxiliary power module 32 is above the cooling temperature threshold, controller 208 may proceed to step 320.

At step 320, controller 208 may compare a signal received from ambient air sensor 254 to the maximum temperature threshold of power electronics 28. Alternatively or additionally, at step 320, controller 208 may compare the temperature signal received from ambient air sensor 254 to a signal received from sensor 256 indicative of a temperature of coolant within primary circuit 202. When controller 208 determines that the temperature of ambient air outside of mobile machine 10 is lower than the maximum threshold temperature of power electronics 28 and/or lower than the temperature of coolant within primary circuit 202 (step 320: No), controller 208 may proceed to step 330.

At step 330, controller 208 may selectively initiate coolant flow to chopper assembly 31 and/or auxiliary power module 32 (power electronics 28) via primary pump 212 and main coolant tank 210 based on the determinations made at step 310. Controller 208 may selectively move control valve 226 to divert coolant flow to one or both of chopper assembly 31 and auxiliary power module 32 via passages 228 and 230. That is, controller 208 may move control valve 226 to a position that selectively directs at least some coolant through chopper assembly 31 when a sensed temperature of chopper assembly 31 is higher than a cooling threshold temperature. Similarly, controller 208 may move control valve 226 to move to a position that selectively directs at least some coolant to auxiliary power module 32 when a sensed temperature of auxiliary power module 32 is higher than a cooling threshold temperature. Alternatively, controller 208 may be configured to direct coolant to chopper assembly 31 and auxiliary power module 32 at predetermined flow rates independent of their actual temperatures. From step 330, controller 208 may return to step 300. When the temperature of the ambient air is higher than the maximum threshold temperature and/or the temperature of the coolant (step 320: Yes), controller 208 may instead proceed to step 340. A determination that the ambient air is higher than the maximum temperature threshold of power electronics 28 or higher than the temperature of the coolant may indicate that mobile machine 10 is operating in an extreme (and temporary) environment, such as in a tunnel. The maximum temperature threshold may correspond to a maximum operating temperature of power electronics 28. When the temperature of ambient air is higher than the maximum operating temperature of power electronics 28 or higher than the temperature of coolant within primary circuit 202, introducing ambient air into heat exchanger 218 may effectively introduce heat into cooling system 200. Based on these comparisons, controller 208 may deactivate blower 219 at step 340. Deactivating blower 219 may also reduce unnecessary energy expenditure.

Controller 208 may also fluidly couple auxiliary coolant tank 240 to power electronics 28 at step 340. In one exemplary embodiment, controller 208 may move outlet and inlet control valves 242, 244 to flow-passing positions such that primary pump 212 draws at least some coolant through auxiliary circuit 204. Because auxiliary circuit 204 may be substantially fluidly isolated from primary circuit 202 during normal operations (e.g., when the temperature of ambient air is lower than the maximum temperature threshold or lower than the coolant temperature) coolant within auxiliary circuit 204 may be substantially cooler than coolant within primary circuit 202 having not yet absorbed heat from primary circuit 202. From step 340, controller 208 may return to step 300.

The disclosed cooling system 200 may provide an efficient mechanism for cooling of a mobile machine 10 during temporary environmental extremes. For example, the disclosed cooling system 200 may provide more effective cooling during tunnel conditions by reducing heat increases through blower usage and by increasing a capacity of cooling system 200 via auxiliary circuit 204. Because cooling system 200 may utilize a separate auxiliary circuit 204, cooling system 200 may also be easily retrofit to older mobile machines or mobile machines unable to accept larger main coolant tanks. Additionally, because cooling system 200 may have an increased thermal capacity, mobile machine 10 may utilize power electronics 28 having lower maximum temperature thresholds, resulting in cost savings.

It will be apparent to those skilled in the art that various modifications and variations can be made to the disclosed cooling system without departing from the scope of the disclosure. Other embodiments of the cooling system will be apparent to those skilled in the art from consideration of the specification and practice of the cooling system disclosed herein. It is intended that the specification and examples be considered as exemplary only, with a true scope of the disclosure being indicated by the following claims and their equivalents.

What is claimed is:

1. A cooling system for a mobile machine having a heat-sensitive component, the cooling system comprising:
a first coolant tank;
a pump configured to circulate coolant from the first coolant tank through the heat-sensitive component;
a heat exchanger configured to receive coolant from the heat-sensitive component and transfer heat to ambient air passing through the heat exchanger;
a blower configured to direct ambient air through the heat exchanger;
a first temperature sensor configured to generate a first signal indicative of a temperature of ambient air; and
a controller in communication with the blower and the first temperature sensor and configured to selectively deactivate the blower based on the first signal.

2. The cooling system of claim 1, further including a second temperature sensor configured to generate a second signal indicative of a temperature of the coolant, wherein the controller is configured to selectively deactivate the blower when the temperature of the ambient air is higher than the temperature of the coolant.

3. The cooling system of claim 2, further including:
a second coolant tank; and
at least one control valve associated with second coolant tank, wherein the controller is further configured to move the at least one control valve to selectively direct coolant from the second coolant tank to the heat-sensitive component based on the temperature of the ambient air.

4. The cooling system of claim 3, wherein the second coolant tank is substantially isolated from the first coolant tank and the heat exchanger when the temperature of the ambient air is lower than the temperature of the coolant.

5. The cooling system of claim 1, wherein the controller is configured to deactivate the blower when the temperature of the ambient air is higher than a maximum temperature threshold of the heat-sensitive component.

6. The cooling system of claim 5, wherein the maximum temperature threshold of the heat-sensitive component is about 70° C.

7. The cooling system of claim 1, wherein the heat-sensitive component includes at least one of a chopper assembly associated with traction motors of the mobile machine and an auxiliary power module.

8. The cooling system of claim 7, further including:
at least one control valve disposed downstream of the first coolant tank and upstream of the chopper assembly and the auxiliary power module;
a third temperature sensor configured to generate a third signal indicative of a temperature of the chopper assembly; and
a fourth temperature sensor configured to generate a fourth signal indicative of a temperature of the auxiliary power module,
wherein the controller is configured to:
move the at least one control valve to selectively direct coolant from the first coolant tank to the chopper assembly based on the third signal; and
move the at least one control valve to selectively direct coolant from the first coolant tank to the auxiliary power module based on the fourth signal.

9. The cooling system of claim 1, further including:
a heat exchanger bypass; and
a valve disposed in the heat exchanger bypass and configured to direct coolant around the heat exchanger when the temperature of the coolant is below a bypass threshold.

10. A method of cooling a mobile machine, comprising:
circulating coolant from a main coolant tank through a heat-sensitive component of the mobile machine;
directing coolant from the heat-sensitive component through a heat exchanger;
activating a blower to generate a flow of ambient air through the heat exchanger;
determining a temperature of the ambient air; and
selectively deactivating the blower based on the temperature of the ambient air.

11. The method of claim 10, further including selectively deactivating the blower when the temperature of the ambient air is higher than a maximum temperature threshold of the heat-sensitive component.

12. The method of claim 11, wherein the maximum temperature threshold is about 70° C.

13. The method of claim 10, further including selectively directing coolant from an auxiliary coolant tank through the heat-sensitive component based on the temperature of the ambient air.

14. The method of claim 10, further including:
determining a temperature of the coolant; and
selectively deactivating the blower when the temperature of the ambient air is higher than the temperature of the coolant.

15. The method of claim 11, wherein:
the heat-sensitive component includes a chopper assembly associated with traction motors of the mobile machine and an auxiliary power module;
the method further includes:
determining a temperature of the chopper assembly;
determining a temperature of the auxiliary power module;
selectively circulating coolant through the chopper assembly based on the temperature of the chopper assembly; and
selectively circulating coolant through the auxiliary power module based on the temperature of the auxiliary power module.

16. A mobile machine, comprising:
a frame;
an engine mounted to the frame;
wheels configured to support the frame;
a traction motor configured to propel the wheels;
an auxiliary power module configured to condition electrical power generated by the engine;
a chopper assembly configured to control power flow through the traction motor;
a first coolant tank supported by the frame;
a pump driven by the engine to circulate coolant through the chopper assembly and the auxiliary power module;
a heat exchanger configured to receive coolant from the chopper assembly and the auxiliary power module and transfer heat from the coolant to ambient air passing through the heat exchanger;
a blower configured to direct ambient air through the heat exchanger;
a first temperature sensor configured to generate a first signal indicative of a temperature of ambient air;
a second temperature sensor configured to generate a second signal indicative of a temperature of the coolant;
a second coolant tank supported by the frame;
at least one control valve associated with the second coolant tank; and
a controller in communication with the blower and the first temperature sensor and configured to:
selectively deactivate the blower based on the first signal; and
move the at least one control valve to selectively direct coolant from the second coolant tank to the chopper assembly and the auxiliary power module based on the second signal.

17. The mobile machine of claim 16, wherein the controller is configured to selectively deactivate the blower when the temperature of the ambient air is higher than the temperature of the coolant.

18. The mobile machine of claim 16, wherein the controller is further configured to deactivate the blower when the temperature of the ambient air is higher than a maximum temperature threshold of the chopper assembly and the auxiliary power module.

19. The mobile machine of claim 16, wherein the second coolant tank is substantially isolated from the first coolant tank and the heat exchanger when the temperature of the ambient air is lower than the temperature of the coolant.

20. The mobile machine of claim 16, further including:
a heat exchanger bypass; and
a valve disposed within the heat exchanger bypass and configured to direct coolant around the heat exchanger when the temperature of the coolant is below a bypass threshold.
